(19) United States
(12) Patent Application Publication
(10) Pub. No.: US 2002/0044528 A1
(43) Pub. Date: Apr. 18, 2002

(54) Flow control method and apparatus

(75) Inventors: Vladimir Pogrebinsky, Issaquah, WA (US); Gur Kimchi, New York, NY (US); Noam Caster, Raanana (IL)

Correspondence Address: DARBY & DARBY P.C., 805 Third Avenue, New York, NY, 10022, US

(73) Assignee: VOCALTEC COMMUNICATIONS LTD., Herzlia (IL)

(21) Appl. No.: 09/955,744

(22) Filed: Sep. 14, 2001

Related U.S. Application Data
(63) Continuation of application No. PCT/IL00/00157, filed on Mar. 14, 2000.
(60) Provisional application No. 60/124,371, filed on Mar. 15, 1999.

(51) Int. Cl. H04L 12/26

(52) U.S. Cl. 370/230; 370/468

(57) ABSTRACT

Methods and apparatus for measuring network bandwidth are disclosed. These methods involve estimating present network bandwidth, transmitting test packets for measuring the available bandwidth, and adjusting the bandwidth, based on said measurement, by changing packet transmission bitrate.

### CROSS REFERENCES TO RELATED PATENT APPLICATIONS

This patent application claims priority from, and is related to, U.S. Provisional Patent Application Ser. No. 60/124,371, entitled METHOD AND APPARATUS FOR TRANSMITTING PACKETS, filed on Mar. 15, 1999, this U.S. Provisional Patent Application incorporated by reference in its entirety herein.

### FIELD OF THE INVENTION

The invention is related to, but is not limited to, a method and apparatus for adjusting bandwidth in a communication network. In particular, the invention is directed to a method and apparatus for adjusting an available bandwidth of a wide area network (WAN).

### BACKGROUND OF THE INVENTION

Data transportation over data communication networks, such as the Internet, involves many independent elements that influence network bandwidth. Those elements may be physical network elements such as routers, bridges, hubs, and the physical links therefor. The elements may be communication devices such as terminals, modems and network interface devices. The elements may also include communication protocols such as TCP/IP and others.

When a terminal transfers data to other terminals over the network, the path of the data from one terminal to others is random and controlled by the routers. When there is a heavy traffic over the network, the routers can create “bottlenecks.” Those bottlenecks may cause to data loss and delays.

There are several methods and tools, that assist the routers to control the data traffic over the network. Those methods and tools typically transmit test packets for learning the packet path and using a statistic to predict the best path for data transaction from one terminal to other terminal.

An example for such a method is PATHCHAR, which is described in the article PATCHAR documentation (Van Jacobson, 1997). PATHCHAR measures the network bandwidth by sending many packets to each hub along the path and recording the Round Trip Time (RTT) (the total time that takes to a packet to travel from a first terminal to a second terminal and back), and processing the results. The PATHCHAR establishes a base bandwidth for every link. This method relies on exact measuring of RTT's and using many records.

PATHCHAR has drawbacks, that include involving sending many packets over the network. Typically its takes hours to measure and establish the network base bandwidth.

Another example of tools for measuring network bottlenecks are described briefly below and in more detail in, “Measuring Bottleneck Link Speed in Packet-Switched Networks” (Carter & Crovella, 1996) and, “Dynamic Server Selection Using Bandwidth Probing in Wide-Area Networks” (Carter & Crovella, 1996) which are incorporated by reference in this application.

A first example tool is Cprobe. This tool sends a series of packets nearly-simultaneously across the path and measures the minimal time that takes the packets to travel along the path and return to the sender. This is known in the art as round trip time (RTT). The Cprobe calculates, from RTT and the size of the packets, the maximum bit rate of the slowest link (bottleneck link) and the minimum base bandwidth of the path.

A second example tool is Bprobe. This tool sends series of packets nearly-simultaneously across the path and measures a time interval from arrival of the first packet to an arrival of the last packet. The result of this measurement is divided by the time interval and results in the packet transmission bitrate under congestion conditions and the available path bandwidth.

The major drawback of the above method and tools for measuring the base bandwidth and the available bandwidth, is that they take a long times to perform measurements and load the network. This affects the quality of audio and video of multimedia applications.

There is a need for a method and apparatus for measuring network bandwidth which mitigates the above disadvantages.

### SUMMARY OF THE INVENTION

The present invention improves on the prior art method and tools for measuring the network base bandwidth and network available bandwidth by providing methods and apparatus for measuring network bandwidth. These methods involve estimating the present network bandwidth, transmitting test packets for measuring the available bandwidth and adjusting bandwidth, based on said measurement, by changing packet transmission bitrate.

In the first aspect of this invention, a method of controlling a packet switched network bandwidth is disclosed. The network includes a plurality of multimedia transceiver for transferring multimedia communications from at least one multimedia transceiver to at least one other multimedia transceiver. The method includes the steps of: transmitting a first type of communication with a first bit rate, transmitting a second type of communications simultaneously with said first type of communication for a predefined period of time, calculating the network bandwidth for providing the network available bandwidth and adjusting packet transmission bitrate in accordance with the network available bandwidth for controlling the network bandwidth.

### BRIEF DESCRIPTION OF THE DRAWINGS

The present invention will be understood and appreciated more fully from the following detailed description taken in conjunction with the appended drawings in which:

FIG. 1 is a diagram of a maximum available bit rate and a used bit rate according to a first embodiment of the invention;

FIG. 2 is a diagram of a maximum available bit rate and a used bit rate according to a second embodiment of the invention;

FIG. 3 is a diagram for showing an algorithm for tracing of available bit rate;

FIG. 4 is a block diagram of a wide area network;

FIG. 5 is a diagram of network load; and

FIG. 6 is a flow chart of a method for adjusting bit rate in accordance with the invention.

### DETAILED DESCRIPTION OF THE INVENTION

The present invention will be described now by the below examples.

### EXAMPLE 1

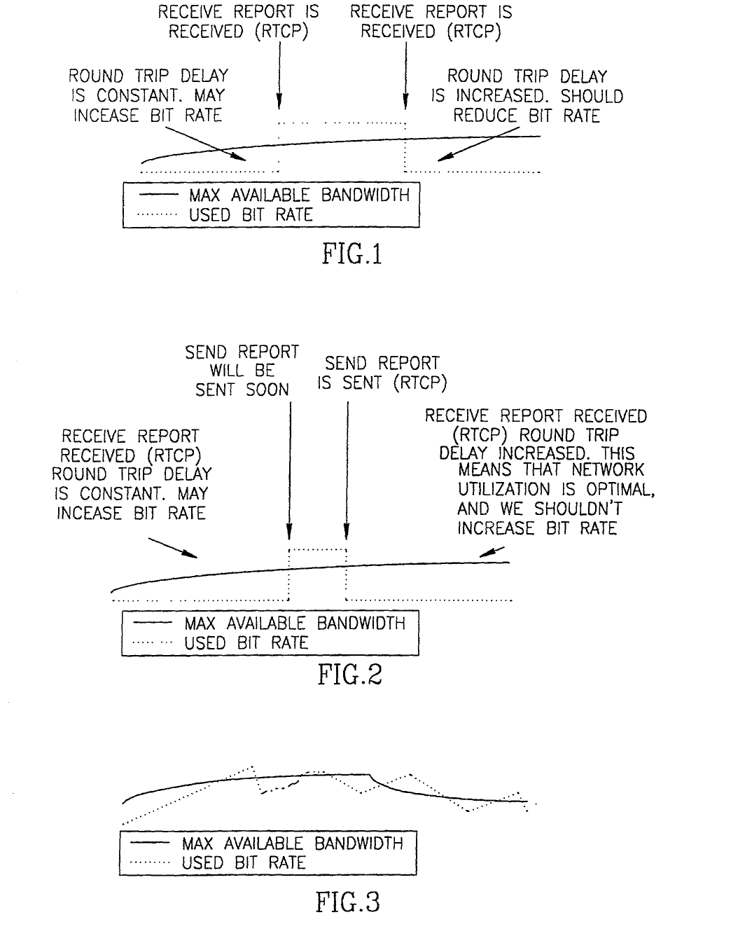

This example will be described with reference to FIGS. 1-3. When using RTP and RTCP for sending audio (the same technique may be applied to video) over the network, such as the Internet, with low bit rate, it is important not to send more data than network can transfer. In other words used bit rate should always be below the available bit rate. When used bit rate is above the available bit rate, data is stored in buffers (in sockets, routers) and is being sent later. When all buffers are full, packets are being lost. This increases transmission delays (packets waits in routers, instead of being sent directly), and can cause packet loss. Both of these factors are undesirable when transmitting real time audio.

In order to avoid these problems, used bit rate should be below the bit rate available in the network (FIG. 3). Additionally, in order to get better network utilization, used bit rate should be very close to the available network bit rate. One such way to achieve network utilization is to use RTCP in order to learn network behavior, such as the round trip delay. As mentioned above, when used bit rate is above the maximum available bit rate, the transmission delay of the packets is increasing. However, when delay is not changing, it may mean that used bit rate is less than the available bit rate, but very close to it (in this case network utilization is close to optimum). It also may mean that used bit rate is much less than the available bit rate (in this case network utilization is bad).

In order to distinguish between these two cases, the following algorithm may be used, as explained in conjunction with FIG. 1. This figure is a diagram for showing the maximum available bit rate in conjunction with the below algorithm.

The first step of the algorithm involves increasing bit rate after having received RTCP and seen that round trip delay is not changing too much. The second step is waiting for next RTCP, and seeing whether round trip delay is affected or not. If the round trip delay was increased, this means that increased bit rate exceeded maximum available bandwidth (i.e. used bit rate already was optimal, and we should return to previous bit rate) and the algorithm stops. If the round trip delay was not changed, it means that network utilization was not optimal, and now it is better. The algorithm is performed in intervals or continuously from the first step to the last, in order to transmits packets only below available bandwidth.

The problem in this algorithm is that when network utilization is already optimal, increases in bit rate for several seconds (between adjacent RTCP packets) may increase delay dramatically, and damage audio quality significantly.

The algorithm above can be improved, as shown in FIG. 2, in order to decrease the damage in audio quality while improving network utilization. The main difference between the two algorithms (the above algorithm and the second or improved algorithm) is instead of increasing bit rate directly after RTCP is received, this second algorithm increases bit rate before sending RTCP test packet(s) and measuring the available bit rate. The first step performed by this second algorithm is to determine if round trip delay stable.

If the round trip delay is not stable, the algorithm stops. If the round trip delay is stable, then an estimate of when the next RTCP packet is made. This estimate tests the available bandwidth and a “Send Report” will be sent, providing a time to send. Then increasing bit rate (from old bit rate, to new bit rate) just before next sent report is sent. The next step is restoring the original bit rate after the send report is sent and waiting for a receive report. If the round trip delay has increased, the network utilization is optimal and the algorithm stopped. If the round trip delay has not changed, then network utilization is not optimal, and bit rate use may be increased safely to new bit rate values, waiting for a time, and returning to the first step.

The advantage of this algorithm is that instead of increasing bit rate for a long time, we have done short “probing” of the network. This action reduces the potential damage of transmitting with bit rate at a minimum above the available bandwidth.

### EXAMPLE 2

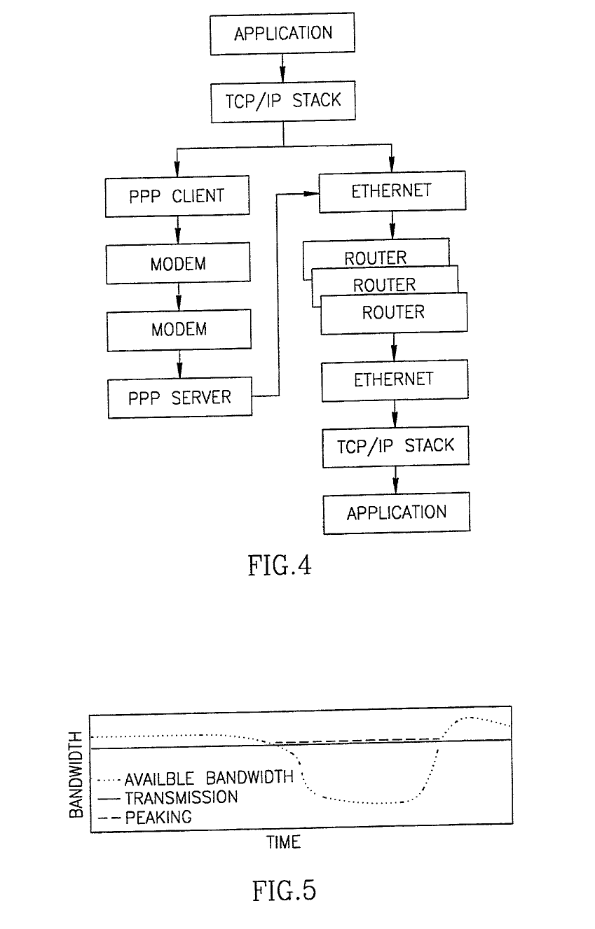

This example will be described with reference to FIGS. 4 and 5. This example is directed to a method for controlling network available bandwidth by a dynamic bit-rate adjustment. The method allows transmission of audio and video on the same path. Systems that use the described bit-rate control behave better when running concurrently with other systems, as they automatically recognize when less or more bandwidth is available, and adjust accordingly. The result is easily demonstrated when sending video. When sending audio on a 14.4 connection, the video almost freezes completely. When this is done automatically, the system recognizes (without input from the application) that less bandwidth is available, and begins to send less low-priority data (video). As soon as audio transmission ceases, the system recognizes that more bandwidth is available and resumes sending video data.

When attempting to send multiple streams, there are similar benefits. Where on a current system more streams will be opened ad-indefinite, resulting in bad transmission quality when bandwidth is overloaded, a system using a dynamic bit rate control (DBRC) algorithm will recognize when there is not enough bandwidth, and will not open any additional streams. Furthermore, when more bandwidth becomes available, the system will automatically allow more streams to open.

The basic rule for dynamic control is to reduce bandwidth faster than it is increased. This is the basis for DSRC. Moreover, this is the reason the bandwidth will not stay on the required bandwidth, but will fluctuate slightly under it. The reason for this is to reduce delay as much as possible. Because the amount of change in the bandwidth, what is sent (the transmission) is in direct proportion to the angle by which the delay was changed. Transmissions do not get “stuck” and they stay dynamic, changing with the available bit-rate.

The algorithm steps include first recognizing when too much data is being sent. This is done by monitoring the network and finding where transmission bottlenecks (congestion in the network) are located (using known methods and tools to locate the bottlenecks), and knowing how to recognize them. The standard route is based on a packet traveling from one host to another (FIG. 4). Delay is created when some node in the travel path becomes overloaded with data. It will start to buffer data, and eventually, if it runs out of buffer space, it will begin to delete data. Because there are many nodes transferring the data, any one can create delay and jitter.

FIG. 5 demonstrates network load when sending too much data (peaking). The straight line shows transmission in a constant bit rate and the curved line shows the available bandwidth. Peaking occurs when transmission bandwidth is above the available bit rate and causes delay in receiving packets. This delay in receiving packets is also the transmission delay.

The next step is receiving a delay value every second from the remote host This is followed by calculating the delay angle over time (or how much has it changed since the last sample). The calculation is done by sampling transmission delay every fixed period, creating a weighted average of delay to smooth sampling errors or: (previous calculated delay/3)+((current delay/3)*2) which gives more emphasis on recent delay samples and cleaned up jitters.

The next step involves adjusting the bit rate with accordance to the delay angle. If the delay Angle (change from last sampled delay) is 0 (zero) the bandwidth is raised by the Abs(last recorded angle)−10%+0.01 to keep from oscillations and upwards slope.

if the Angle <0, raise the bandwidth by Abs(angle)−10% to “lose” delay.

if the Angle >0, drop the bandwidth by the angle +10%-reduce bandwidth faster then it is increased.

### EXAMPLE 3

The suggested algorithm assumes that each channel or channels group is an independent entity, struggling to do it's best in passing real-time high-quality audio without any other hints. A channel(s) group is defined as one or more channels with the same destination IP. These channels will share the same bandwidth resources and therefore a central resource detection and allocation mechanism is needed for such a group.

Higher mechanisms may detect common paths (or partly common) to channels and inform the gateways how should they act. Application level decisions, such as priority levels to different users, may also come into account n determining the bandwidth usage of channels.

The suggested bitrate control algorithm will detect the bitrate margin (available bandwidth), and if possible, will raise the current used bitrate so that it will utilize the bandwidth, but will always keep the safety margin from the upper limit. If the algorithm detects a decrease in margin, it will immediately lower down the bitrate. Another indication which will be used to lower the bitrate is the increase of the packet arrival delay, as described in Example 2 (above).

The algorithm strategy utilized is “safe and polite”.

1. Safe—we will try to avoid utilization of the full seemingly available bandwidth, in order to minimize the possibility of causing a degradation in quality due to bandwidth abusing.

2. Polite—the algorithm will not use all the bandwidth it can (within the safety margins), but only part of it. This will prevent choking other gateway channels (from the same gateway or not) and will help balancing the channels' available bandwidth. The algorithm will free bandwidth when it detects overuse of bandwidth. This will clear the way for new channels, which will start at low bitrate, and if possible, raise the bitrate.

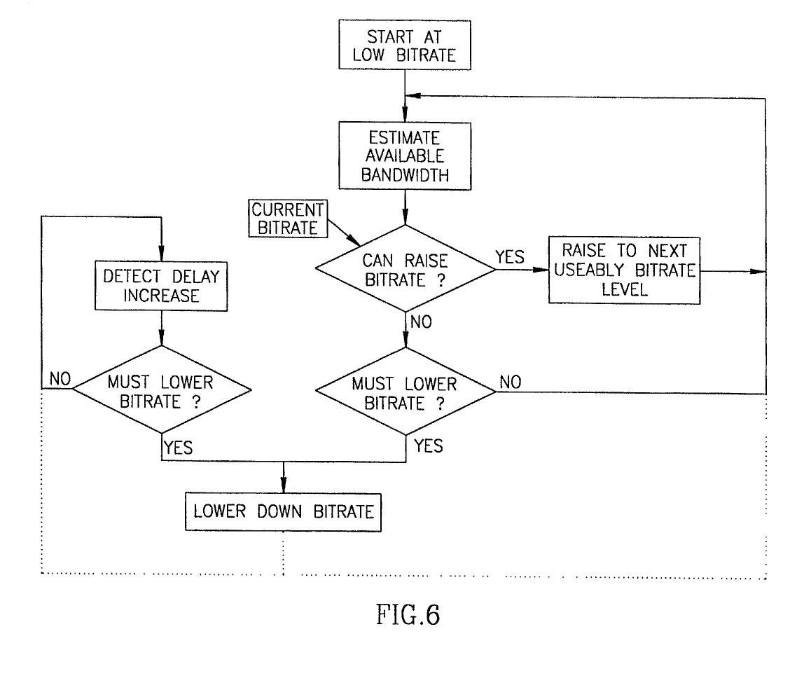

The algorithm steps will be described with reference to FIG. 6 as follows. The first step is estimating the maximum bandwidth (BW) of the bottleneck router (using Bprobe tool). This is done with large packets (approximately 1000 bit), that provide absolute results. The first step will provide the basic available bandwidth to be adjusted by the bit rate control. The second step is determining a safety margin below the available bit rate, for the algorithm to follow. This safety margin can be, for example, 10% below the basic available bandwidth and maybe lowered upon the statistical measurement of the algorithm behavior.

The third step is transmitting media packets with initial bit rate, that was set with accordance to the basic available bandwidth. The forth step is determining the trimming factor of the router. This is done by sending small packets (min is 224 UDP header) for Bprobe, measure the BW and finding the trimming factor of the router D_{forw,}. This provides small packets for further measurements, and is done by sending more probe packets at the beginning, and fewer probe packets after the general bandwidth was established.

The fifth step is probing the network using a Cprobe technique. The packets will be sent with delay, so that the sent BR will be equal to the measured BW. This enables use of smaller packets and to use them more effectively—the more time the probing will be held, the more accurate it will be. The sending of probe packets is done only at end of a talkspurt, and only if Tₘᵢₙ elapsed from last probing. This is valid if it is assumed that the available bandwidth will change slower then the average talkspurt length.

The last step is adjusting the bit rate in accordance with the above measurements. Raising bit rate is done by using the below equation. When increasing the bitrate, the algorithm will not use all the available bandwidth for three primary reasons.

First, bandwidth estimation is not accurate and may vary, Dₑₛₜ [b/s] will denote it's deviation. Second, bandwidth itself may change rapidly, D_{bw} [b/s] will denote it's deviation.

In order to prevent the generated streams from competing on available resources, each line will not capture all the seemingly available bandwidth, but only a portion of it, leaving residue denoted by BWᵣₑₛ [b/s].

Therefore, if the detected available bandwidth is denoted as BW_{left} [b/s], the next usably bitrate level BRₙₑₓₜ [b/s] and the current bitrate level as BR_{cur} [b/s], the bitrate will be raised only if:

BW_{left}−(BWᵣₑₛ+D_{bw}+Dₑₛₜ)>BRₙₑₓₜ−BR_{cur}

The rate at which the bitrate is raised will be slow, in general (10's of seconds). This rate can depend on the channel's bitrate level or a pre-set priority:

In general, the algorithm is more aggressive (faster in raising bitrate) for low bitrate levels (e.g.: for the lowest bitrate level, the channel will assert itself without checking at all).

Application level aggression is pre-set (for high-priority channels).

Lowering the bitrate will be done either when a decrease in the available bandwidth is detected, or by detecting an increase in the packet arrival delay. Again, similarly to the previous section, the bitrate will be lowered when:

BW_{left}−(BWᵣₑₛ+D_{bw}+Dₑₛₜ)<0

Generally, the algorithm will lower bitrate level as soon as it has the ability to do so (end of talkspurt or previous).

While preferred embodiments of the present invention have been described so as to enable one of skill in the art to practice the present invention, the preceding description is exemplary only, and should not be used to limit the scope of the invention. The scope of the invention should be determined by the following claims.

1. A method of controlling a packet switched network bandwidth which includes a plurality of multimedia transceiver for transferring multimedia communications from at least one multimedia transceiver to at least one other multimedia transceiver, wherein the method comprising the steps of:
transmitting a first type of communication with a first bit rate;
transmitting a second type of communication simultaneously with said first type of communication for a predefined period of time;
calculating said network bandwidth for providing said network available bandwidth; and
adjusting packet transmission bitrate in accordance with said network available bandwidth for controlling said network bandwidth.

2. The method of claim 1, wherein in the step of transmitting the second type of communication comprises the step of increasing transmission bit rate.

3. The method of claim 1, additionally comprising the step of monitoring, said monitoring including:
requesting for network available bandwidth;
restoring transmission bit rate to the first bit rate; and
receiving network available bandwidth.

4. A method for controlling data transportation over a network, comprising the steps of:
a. transmitting data at a first bit rate;
b. detecting an available bandwidth of said network, said detection being in real time and substantially simultaneous with said transmission of data with a first bit rate; and
c. transmitting data at a second bit rate, said second bit rate being in accordance with said available bandwidth of said network that was detected in step (b).

5. The method of claim 4, wherein the transmission of data over said network is over a path of a network having a predetermined maximum bandwidth, and
the step of detecting an available bandwidth of said network, includes:
transmitting data at a first bit rate;
transmitting at least one test data packet in an increased bit rate for detecting at least one congestion in the path; and
transmitting data at said first bit rate and receiving a result of said detection.
